(19) United States
(12) Patent Application Publication
(10) Pub. No.: US 2006/0064653 A1
(43) Pub. Date: Mar. 23, 2006

(54) Automatic layout yield improvement tool for replacing vias with redundant vias through novel geotopological layout in post-layout optimization

(76) Inventors: Shuo Zhang, Sunnyvale, CA (US); Yongbo Jia, Fremont, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/946,686

(22) Filed: Sep. 21, 2004

(51) Int. Cl. G06F 17/50; G06F 9/45

(52) U.S. Cl. 716/2; 716/10; 716/13

(57) ABSTRACT

The present invention provides a new way of improving yield in the physical design stage after detail routing, thereby optimizing integrated circuit (IC) layout designs for manufacturing. Embodied in an automatic layout yield improvement tool, the present invention replaces vias with redundant vias having redundant cut shapes or larger metal overlapping based on a novel geotopological approach to routed layout optimization. The geotopological approach enables the most favorable redundant via candidate to be selected for each modifiable regular via. The tool first checks all potential redundant vias in the order of yield favorableness. The modifiable regular via is then replaced by an ideal redundant via that does not introduce any design rule violations in the geotopological layout. Overcoming the fundamental limitation of geometrical-based solutions and taking advantage of the modification flexibility of the geotopological approach, this invention achieves highly desirable redundant via usage rate and substantial yield improvement.

### CROSS-REFERENCE TO RELATED APPLICATIONS

This application relates to a co-pending U.S. patent application Ser. No. ______, which is filed concurrently herewith and entitled, “ROUTED LAYOUT OPTIMIZATION WITH GEOTOPOLOGICAL LAYOUT ENCODING FOR INTEGRATED CIRCUIT DESIGNS,” and which is incorporated herein by reference in its entirety.

### BACKGROUND OF THE INVENTION

1. Field of the Invention

This invention relates generally to integrated circuit designs and post-layout optimization therefor. More particularly, it relates to a new automatic layout yield improvement tool capable of optimally replacing regular vias with redundant vias through a novel geotopological layout after detail routing in the physical design flow.

2. Description of the Related Art

In the highly competitive semiconductor industry, integrated circuit (IC) design requirements and optimization targets, such as timing, SI, yield, manufacturability, etc., are constantly changing. Today, a state-of-art integrated circuit usually contains tens of millions of transistors and over a million of metal wires on a single chip. To achieve a dense design on a very small footprint, automatic physical design tools use minimum spacing rules and minimum width wires to ensure that vias generated or used are within the minimum area.

In the ultra deep sub-micron lithographic process, vias are formed with a size less than a 1/20 square micron. Understandably, these delicate vias are very fragile and can easily be broken or damaged. In addition to small via size, random manufacture variation could also cause via breaking. Considering a single defective via can almost certainly ruin the entire design, via breaking is one of the most critical reliability problems responsible for the relatively low average yield in the semiconductor manufacturing industry.

A regular via that crosses two metal layers is composed of three geometries in the layout, one in the lower metal layer, one in the upper metal layer, and one in the cut layer, which is the insulation layer between the two metal layers. The size of the regular via metal layer geometry is not smaller than the cut layer geometry. Via breaking means that the actual metal connection between the cut layer geometry and either metal layer geometry is broken. Therefore, increase the size of the cut layer geometry should lower the possibility of via breaking.

Because the cut layer geometry has a fixed size specified according to the manufacture design rule, to increase the size of a cut layer geometry in a via is to add one or more extra cut geometries into the via. Such a via is referred to as a redundant via. Most of the time a redundant via has an extra cut geometry.

A redundant via also refers to a via with only one cut geometry and two larger-than-minimum metal geometries. This kind of redundant via is useful in situations where there is not place for the extra cut geometry.

In general, a redundant via has larger geometries than a regular via so that the possibility of breaking is much smaller. Thus, to minimize or reduce the risk of via breaking, redundant vias are commonly used to replace regular vias in the layout.

Since redundant vias inevitably put more metal into the layout than regular vias, a problem remains in how to introduce redundant vias without causing or invoking any design rule violations. Many commercially available electronic design automation (EDA) tools for IC layout designs, for instance, Cadence NanoRoute™, Synopsys Astro™, Mentor Calibre™, and BindKey RapiDesignClean™, have attempted to address the problem with various solutions.

The flow for designing an integrated circuit can be roughly divided into the logical design phase and the physical design phase. The logical design phase includes several design stages: from the design specification to architectural behavioral design stage, to the register transfer level (RTL) design stage, to the gate design stage, after which the logical IC design is ready for the physical design phase. The physical design phase includes floor planning, placement, and routing, which produces the physical IC design layout.

One of the solutions is simply to have the automatic physical design tool introduce the redundant vias during the routing stage. However, due to the high complexity and large scale of routing task, this routing introduction would result in larger die size or slower design timing. The additional cost of undesirable larger die area and/or slow design performance is counterproductive to the yield increase resulted from universal redundant via usage.

Another solution is to manually insert redundant vias into the layout after routing. This method is impractical for most IC designs since the number of vias in the layout is in the millions.

Other prior solutions, such as those disclosed in the U.S. Pat. No. 5,798,937, entitled, “METHOD AND APPARATUS FOR FOMRING REDUNDANT VIAS BETWEEN CONDUCTIVE LAYERS OF AN INTEGRATED CIRCUIT,” U.S. Pat. No. 6,026,224, entitled, “REDUNDANT VIAS,” and U.S. Pat. No. 6,715,133, entitled, “METHOD FOR ADDING REDUNDANT VIAS ON VLSI CHIPS,” add redundant vias into a routed layout, i.e., after detail routing, through some automatic layout tools.

These prior solutions are based on the traditional geometrical layout representation. In a geometrical layout the wire path of every net has a determined shape and position. These wire paths necessarily impose geometrical constrains on any modification to the routed layout. Consequently, these geometrical-based automatic physical design tools usually achieve a redundant via usage rate of only 40-60%. That is, they have a fundamentally limited capability to put enough redundant vias into the design for yield improvement without introducing design rule violations.

As the process technology advances into smaller and smaller feature size and the manufacture requirement of the redundant via usage rate is approaching 75% or even higher, there is a urgent need of a new automatic layout optimization solution that can provide higher redundant via replacement ratio for substantial yield improvement without increasing the die size and without adversely affecting the design performance. The present invention addresses this need.

### BRIEF SUMMARY OF THE INVENTION

The present invention provides a new way of optimizing integrated circuit (IC) layout designs for manufacturing. Embodied in an automatic layout yield improvement tool, the present invention replaces vias with redundant vias having redundant cut shapes or larger metal overlapping, based on a novel geotopological approach to routed layout optimization.

More specifically, in the geotopological approach, a routed layout with geometrical wiring paths is transformed into a geotopological layout in which unmodifiable nets are represented by geometrical wiring paths and modifiable nets are represented by topological wiring paths. Based on a geotopological layout encoding graph, all layout modifications are performed on the modifiable nets according to applicable design rules and desired optimization targets, leaving the unmodifiable nets intact. A new geometrical layout is regenerated, combining unmodifiable nets and nets modified for the targeted optimization.

Unlike the prior solutions, the geotopological approach advantageously eliminates geometrical constraints of non-critical nets, thereby providing the maximum flexibility for routed layout modifications. The automatic layout yield improvement tool disclosed herein implements the geotopological approach to enable the most favorable redundant via candidate to be selected for each modifiable regular via. First, it checks all potential redundant vias in the order of yield favorableness. Then, it checks suitable redundant via candidates for design rule violations. The modifiable regular via is replaced by the most yield favorable redundant via that does not introduce any design rule violations in the geotopological layout.

According to an aspect of the present invention, the automatic layout yield improvement tool provides two redundant via replacement models. The high speed model focuses on replacing vias with yield favorable redundant vias within a short time. The high rate model focuses on achieving the highest redundant via usage rate.

Overcoming the fundamental limitation of geometrical-based solutions and taking advantage of the modification flexibility of the geotopological approach, the inventive automatic layout yield improvement tool achieves highly desirable redundant via usage rate and significant yield improvement. For a state-of-art IC design routed by commercial routing tools with average routing density, the automatic layout yield improvement tool can achieve over 90% redundant via usage rate consistently through the high speed model, and even higher, i.e., 2-5% more, through the high rate model.

Other objects and advantages of the present invention will become apparent to one skilled in the art upon reading and understanding the preferred embodiments described below with reference to the following drawings.

### BRIEF DESCRIPTION OF THE DRAWINGS

FIG. 1 illustrates a high speed redundant via replacement flow according to an embodiment of the present invention.

FIG. 2 illustrates a high rate redundant via replacement flow according to another embodiment of the present invention.

FIGS. 3-5 together illustrates the geotopological approach according to an aspect of the present invention.

FIG. 6 show three redundant via prototypes for an exemplary regular via.

FIG. 7 shows a plurality of possible double via replacement directions for replacing the exemplary regular via.

FIG. 8 shows a list of redundant via candidates for the exemplary regular via.

FIG. 9 shows an original layout with regular vias having two metal layers.

FIGS. 10-11 compare the redundant via replacement results between the present invention (FIG. 10) and that of a prior art tool (FIG. 11).

### DETAILED DESCRIPTION OF THE INVENTION

In the following detailed description, like numbers and characters may be used to refer to identical, corresponding, or similar items in different figures.

The present invention provides a layout optimization tool to introduce redundant vias into a layout after routing. These redundant vias replace regular vias, lowering the possibility of via breaking and improving layout yield. Based on a novel geotopological layout optimization flow disclosed in the above-referenced co-pending U.S. patent application, the present invention achieves significantly higher redundant via usage rate, i.e., over 90%, without creating any design rule violations in the routed layout.

The geotopological approach to routed layout optimization flow is a significant improvement derived from a topological approach developed by the inventor, see, Zhang, S. and Dai, W. “TEG: A New Post-Layout Optimization Method,” IEEE Transactions on Computer-Aided Design of Integrated Circuits and Systems, Vol. 22, No. 4, April 2003, pp. 1-12, the content of which is incorporated herein by reference in its entirety. Readers are referred to the above-referenced co-pending U.S. patent application and the topological approach article for further teachings on these two approaches and underlying operations such as layout updates, design rule check, wire representations, etc.

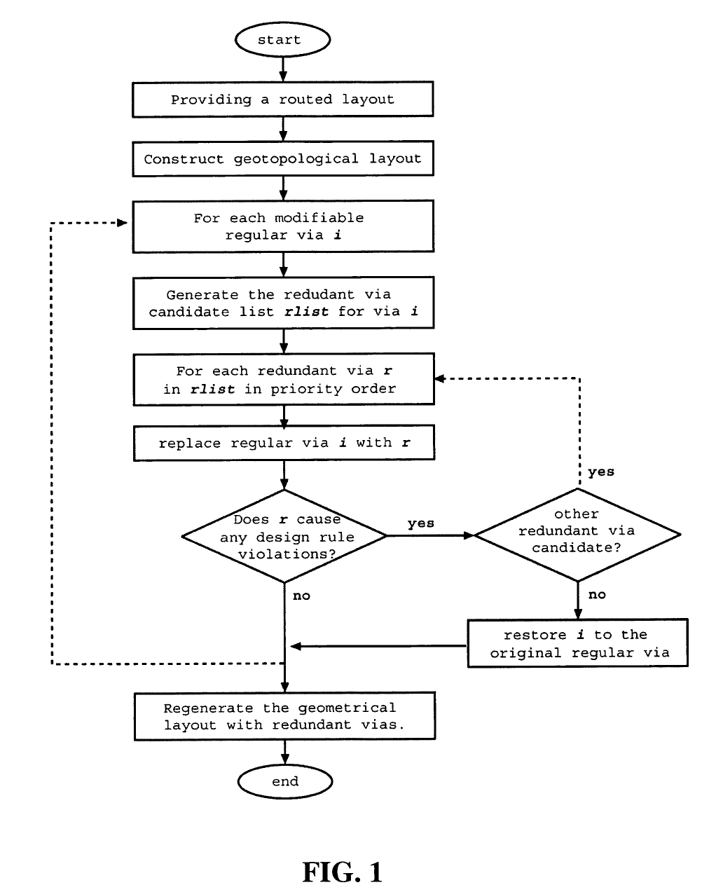

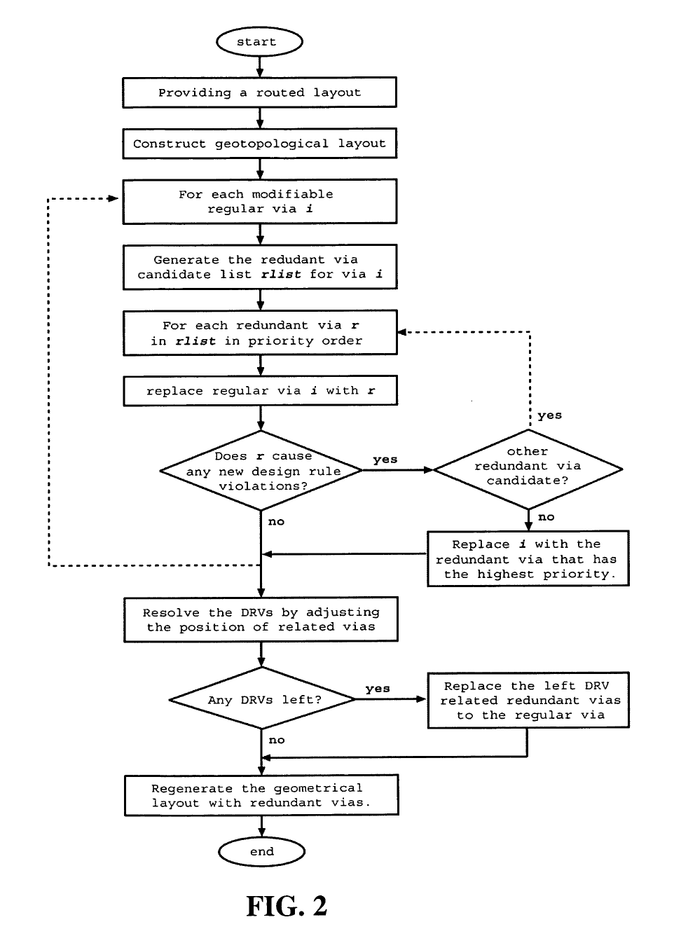

The layout optimization tool of the present invention, called the automatic layout yield improvement (ALYI) tool, includes two redundant via replacement flow models. Flow 1 is called the high speed model, which focuses on completing the redundant via replacement within a short time. The high speed flow is illustrated in FIG. 1. Flow 2 is call the high rate model, which focuses on achieving the highest redundant via usage rate of about 90-95% and more. The high rate flow is illustrated in FIG. 2.

Referring to FIG. 1, first, a routed layout is provided. In this geometrical layout, the routing of some nets is not modifiable due to the timing result or other design requirements. According to this information, a geotopological layout is next constructed as described in the above-referenced co-pending U.S. patent application.

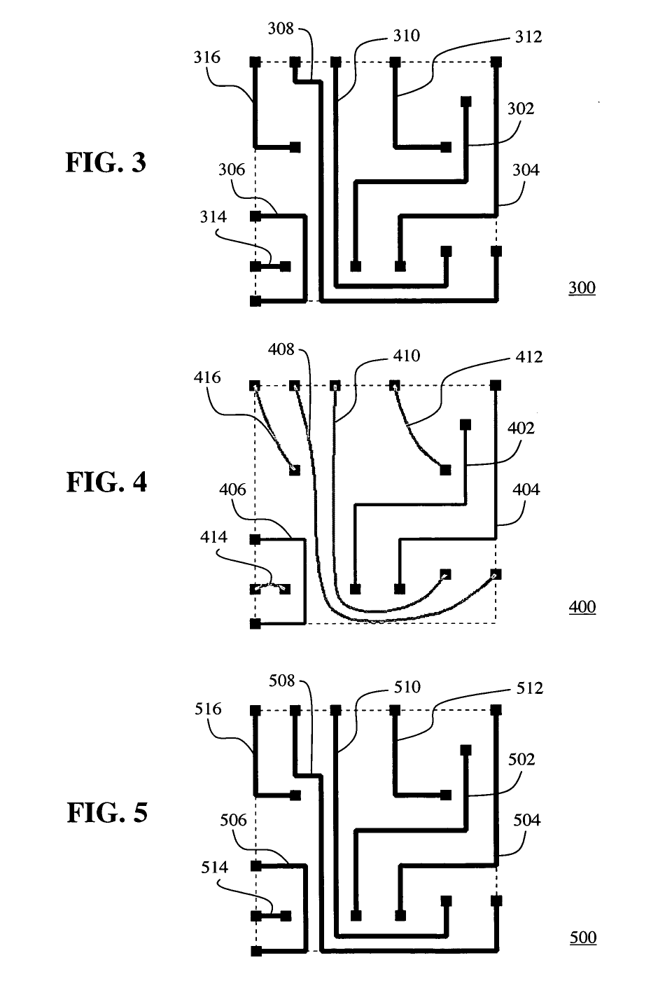

Generally, as shown in FIGS. 3-5, in the geotopological approach, a routed layout 300 with geometrical wiring paths 302-316 is transformed into a geotopological layout 400 in which unmodifiable nets 302-306 are represented by geometrical wiring paths 402-406 and modifiable nets 308-316 are represented by topological wiring paths 408-416. Based on a corresponding geotopological layout encoding graph (not shown), all layout modifications are performed on the modifiable nets according to applicable design rules and desired optimization targets, leaving the unmodifiable nets intact. A new geometrical layout 500 is regenerated, combining unmodifiable nets 502-506 and optimized nets 508-516.

Referring to FIGS. 1 and 4, the ALYI tool checks each modifiable net in the geotopological layout and replaces the regular via with a redundant via. For each regular via i that is modifiable, i.e., represented by its topological wiring path in the geotopological layout, a redundant via candidate list rlist is generated for this specified i.

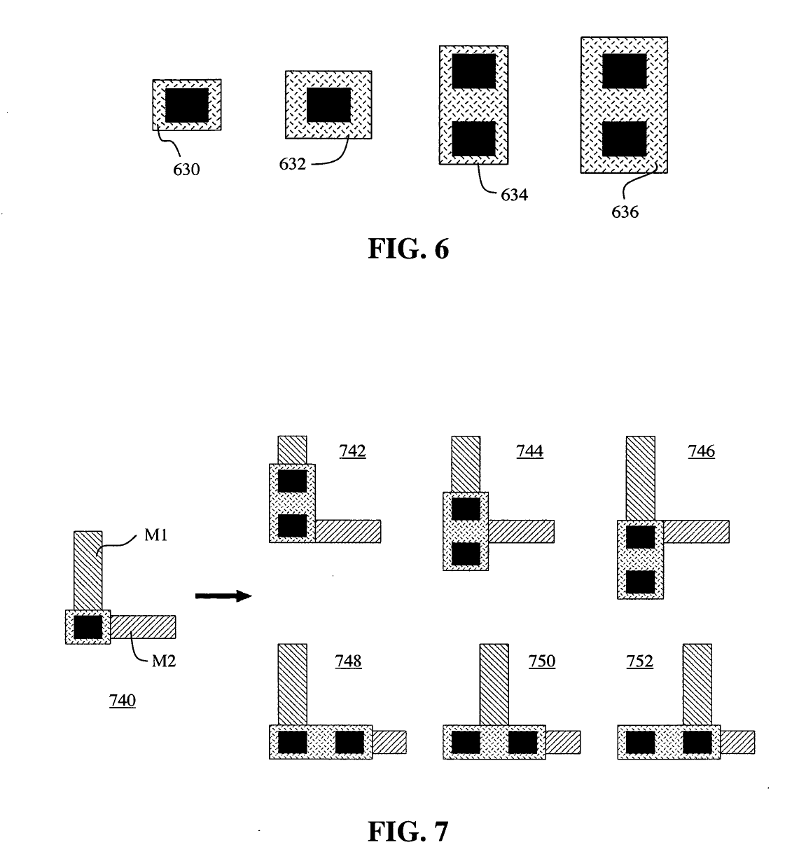

In a redundant via optimization, the designer or the fabrication line often provides multiple redundant via prototypes. FIG. 6 illustrates three redundant via prototypes 632-636 for an exemplary regular via 630. The regular via 630 has one geometry in the cut layer, represented by the solid black rectangle, and two same size geometries on both metal layers, represented by the patterned rectangle. The redundant via 632 has one cut geometry and two metal geometries with enlarged cut overhanging. The redundant via 632 is also called a fat single via. The redundant via 634 is called the normal double via, having two cut geometries and minimum metal overhanging. The redundant via 636, which is called a fat double via, has two cut geometries and an enlarged cut overhang.

From the manufacturability viewpoint, the fat double via has the least possibility of via break and the best yield improvement, followed by the normal double via, and then the fat single via. According, in the redundant via optimization, the fat double via is the most preferred redundant via candidate among these three prototypes and therefore has the highest priority to be used in replacing a normal via.

In addition to the multiple redundant via prototypes, the ALYI tool also takes into consideration the direction of via placement as a factor in generating the redundant via candidate list rlist. For example, for a specified regular via, different replacement direction of the double via has different influence on the layout.

FIG. 7 illustrates a plurality of possible double via replacement directions 742-752 for replacing a regular via 740 that connects to two metal layers, M1 and M2. At the regular via 740, the net wire path travels up in M1 and goes right at M2. In this example in which double via is used to replace the regular via 740, there are six placement directions 742-752 that have the same degree of the yield improvement.

Via 742-746 are in the vertical direction. Since M1 is in the vertical direction and M2 is in the horizontal direction, these three placement directions cause more changes in the M2 layer than in the M1 layer. To analyze further, via 742 is the upper vertical placement with which very little change would occur in the M1 layer. The middle vertical placement 744 would cause more changes below the via than via 742. The lower vertical placement 746 would cause even more changes in the M1 layer. Among these three placement directions, via 742 is the most preferred candidate for replacing via 740 because it would cause the least change on the routed layout and the least potential influence on the design performance. Similarly, vias 748-752 are horizontal placements and favor the M2 layer. Via 748 would cause the least change to the M2 layer, so it has the highest priority, followed by via 750 and via 752.

The ALYI tool considers both redundant via prototypes and placement directions and generates the overall redundant via candidate list rlist accordingly. The list is prioritized based on the degree of yield improvement, layout preferences, and layout changes.

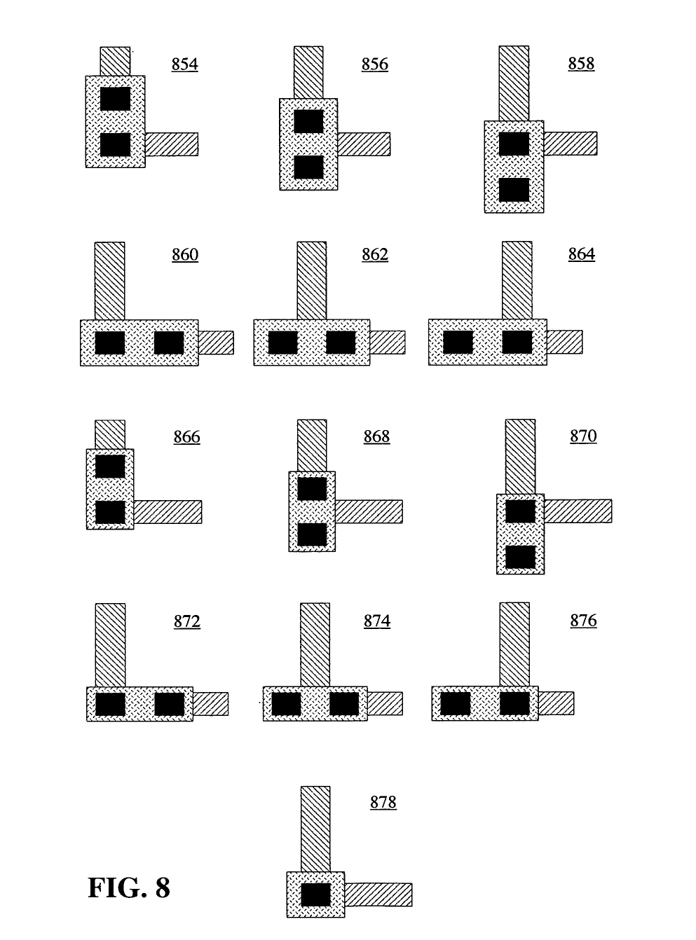

FIG. 8 shows an exemplary list of redundant via candidates 854-878 for the regular via 740 in FIG. 7. Assuming M1 is the layer that is preferred to have less changes, the redundant vias are, in the order of priority from the highest to the lowest, vertical fat double via 854-858, horizontal fat double via 860-864, vertical normal double via 866-870, horizontal normal double via 872-876, and fat single via 878.

Referring back to FIG. 1, after the redundant via candidate list rlist is generated for a specified modifiable regular via i, the ALYI tool operates to replace the regular via i with a redundant via r from the rlist with the highest priority. As discussed before, replacing a regular via with a redundant via would cause changes on both metal layers. A geotopological design rule checker (see above-referenced co-pending U.S. patent application) determines whether a replacement would introduce any design violations in either layer. If so, another attempt is made to replace this regular via i with the next redundant via in the candidate list. If not, the current redundant via r replaces this regular via i and the process goes back to replace the next regular via.

In the situation that every redundant via candidate on rlist would cause design rule violations, the regular via i will not be changed in the high speed flow. After all modifiable regular vias have been processed and replaced with redundant vias where applicable, a new geometrical layout like the one shown in FIG. 5 is regenerated.

Referring back to FIG. 2, in the high rate redundant via replacement flow, each modifiable regular via i is first similarly processed as in the high speed model until a design rule violation occurs in every redundant via candidate on the rlist. Instead of giving up using a redundant via for this specified regular via i, this high rate flow uses the redundant via with the highest priority. In this manner, after every regular via is processed, there could be some design rule violations (DRV) left in the geotopological layout. The ALYI tool then operates to resolve the DRV violations with a DRV solver that adjusts the position of the related vias. Readers are directed to the above-referenced article for further details on the DRV solver. The DRV solver can resolve most DRVs.

The remaining DRVs can be further resolved by restoring the related redundant vias to the original regular vias i. By doing so, a status is reached where this is no DRV in the geotopological layout, since the redundant via is the only reason that the layout has DRVs. When all regular vias have been processed and the no DRV status is reached, a new geometrical layout is regenerated accordingly.

Compared with the high speed model, this high rate replacement model achieves higher redundant via usage rate. By adjusting the position of the vias, the high rate flow further utilizes the modification flexibility of the geotopological layout, although at the expense of some extra computing time for the DRV solver.

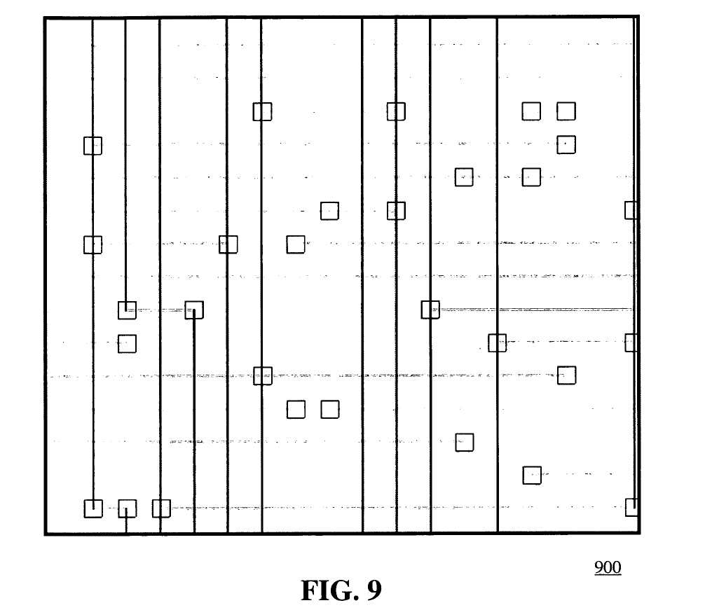

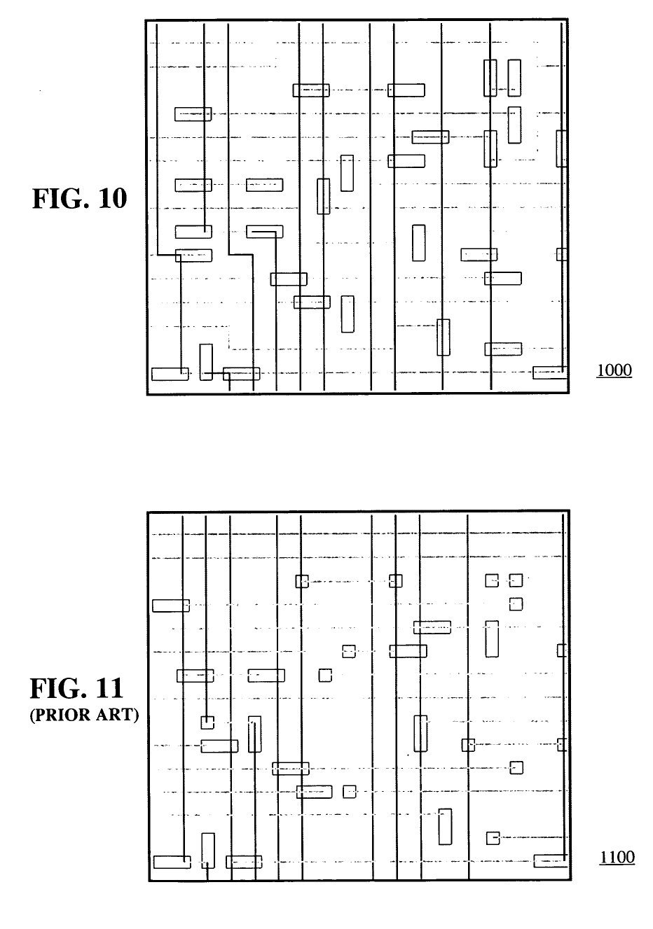

FIGS. 9-11 illustratively compare the redundant via replacement results between the present invention and that of a prior art tool. FIG. 9 shows an original layout 900 with regular vias having two metal layers as described above. FIG. 10 shows a geometrical layout regenerated utilizing the redundant via replacement method described herein and the ALYI tool implementing the method. FIG. 11 shows a sample layout 1100 generated as a result of a known redundant via method. Because the present invention has the ability to change the wire paths so that more layout resource is available to the redundant vias, more redundant vias are put into the layout 1000 as compared to the layout 1100, thereby producing an optimized layout that is more reliable, i.e., lower possibility of via breaking, and has higher yield improvement than prior art methods and tools.

As one skilled in the art will appreciate, most digital computer systems can be programmed to implement the present invention. To the extent that a particular computer system configuration is programmed to implement the present invention, it becomes a digital computer system within the scope and spirit of the present invention. That is, once a digital computer system is programmed to perform particular functions pursuant to computer-executable instructions from program software that implements the invention described heretofore, it in effect becomes a special purpose computer particular to the present invention. The necessary programming-related techniques are well known to those skilled in the art and thus are not further described herein for the sake of brevity.

Computer programs implementing the invention described herein can be distributed to users on a computer-readable medium such as floppy disk, memory module, or CD-ROM and are often copied onto a hard disk or other storage medium. When such a program of instructions is to be executed, it is usually loaded either from the distribution medium, the hard disk, or other storage medium into the random access memory of the computer, thereby configuring the computer to act in accordance with the invention disclosed herein. All these operations are well known to those skilled in the art and thus are not further described herein. The term “computer-readable medium” encompasses distribution media, intermediate storage media, execution memory of a computer, and any other medium or device capable of storing for later reading by a computer a computer program implementing the invention disclosed herein.

Although the present invention and its advantages have been described in detail, it should be understood that the present invention is not limited to or defined by what is shown or described herein. As one of ordinary skill in the art will appreciate, various changes, substitutions, and alterations could be made or otherwise implemented without departing from the principles of the present invention. Accordingly, the scope of the present invention should be determined by the following claims and their legal equivalents.

What is claimed is:

1. A method of replacing a regular via with a redundant via in routed layout optimization, wherein said routed layout having a plurality of nets, said method comprising the steps of:
utilizing a geotopological layout transformed from said routed layout, said geotopological layout simultaneously representing unmodifiable nets with geometrical wiring paths and modifiable nets with topological wiring paths;
for each of modifiable regular via in said modifiable nets,
generating a redundant via candidate list;
prioritizing redundant via candidates on said list; and
replacing said modifiable regular via with a redundant via having the highest priority.

2. The method of claim 1, further comprising the steps of:
determining whether said replacing step causes any design rule violations; and
restoring said modifiable regular via or processing the next modifiable regular via according to said determining step.

3. The method of claim 1, further comprising the steps of:
determining whether said replacing step causes any design rule violations; and
resolving applicable design rule violations by adjusting positions of one or more related vias.

4. The method of claim 3, wherein said design rule violations cannot be resolved by adjusting said positions, further comprising the step of:
restoring said modifiable regular via.

5. The method of claim 1, wherein the step of generating a redundant via candidate list further comprises the steps of:
considering both redundant via prototypes and placement directions thereof; and
selecting said redundant via candidates from a combination of said redundant via prototypes and said placement directions.

6. The method of claim 5, wherein
said placement directions include vertical and horizontal; and wherein
said redundant via prototypes include fat single via, double via, and fat double via.

7. The method of claim 1, wherein the step of prioritizing further comprising the step of:
assigning priority to each redundant via candidate based on the degree of yield improvement, layout preferences, and layout changes.

8. The method of claim 1, further comprising the step of:
regenerating a new geometrical layout after all modifiable regular vias in said geotopological layout have been processed and replaced where applicable with suitable redundant vias from said list without causing any design rule violations.

9. The method of claim 1, further comprising the step of:
regenerating a new geometrical layout after all modifiable regular vias in said geotopological layout have been processed and replaced where applicable with suitable redundant vias from said list and after all design rule violations have been resolved.

10. A computer system programmed to perform the method steps of claim 1.

11. A computer-readable medium storing a computer program implementing the method steps of claim 1.

12. A computer-readable medium storing a computer program implementing the method steps of claim 2 and the steps of:
considering both redundant via prototypes and placement directions thereof;
selecting said redundant via candidates from a combination of said redundant via prototypes and said placement directions; and
assigning priority to each redundant via candidate based on the degree of yield improvement, layout preferences, and layout changes; wherein
said placement directions include vertical and horizontal; and wherein
said redundant via prototypes include fat single via, double via, and fat double via.

13. The computer-readable medium of claim 12, further storing a computer program implementing the steps of:
regenerating a new geometrical layout after all modifiable regular vias in said geotopological layout have been processed and replaced where applicable with suitable redundant vias from said list without causing any design rule violations.

14. A computer-readable medium storing a computer program implementing the method steps of claim 3 and the steps of:
considering both redundant via prototypes and placement directions thereof;
selecting said redundant via candidates from a combination of said redundant via prototypes and said placement directions; and
assigning priority to each redundant via candidate based on the degree of yield improvement, layout preferences, and layout changes; wherein
said placement directions include vertical and horizontal; and wherein
said redundant via prototypes include fat single via, double via, and fat double via.

15. The computer-readable medium of claim 13, further storing a computer program implementing the steps of:
restoring said modifiable regular via where said design rule violations cannot be resolved by adjusting said positions; and
regenerating a new geometrical layout after all modifiable regular vias in said geotopological layout have been processed and replaced where applicable with suitable redundant vias from said list and after all design rule violations have been resolved.
